(19) United States
(12) Patent Application Publication
(10) Pub. No.: US 2017/0235649 A1
(43) Pub. Date: Aug. 17, 2017

(54) CONTAINER AWARE NETWORKED DATA LAYER

(71) Applicants: JIGNESH KAUSHIK SHAH, FREMONT, CA (US); SUMEET KEMBHAVI, PUNE (IN); VENKATRAMAN LAKSHMINARAYANAN, CHENNAI (IN); RAHUL RAVULUR, CUPERTINO, CA (US); ADITYA VASUDEVAN, MOUNTAIN VIEW, CA (US); ASHISH PURI, PUNE (IN)

(72) Inventors: JIGNESH KAUSHIK SHAH, FREMONT, CA (US); SUMEET KEMBHAVI, PUNE (IN); VENKATRAMAN LAKSHMINARAYANAN, CHENNAI (IN); RAHUL RAVULUR, CUPERTINO, CA (US); ADITYA VASUDEVAN, MOUNTAIN VIEW, CA (US); ASHISH PURI, PUNE (IN)

(21) Appl. No.: 15/379,455

(22) Filed: Dec. 14, 2016

Related U.S. Application Data
(60) Provisional application No. 62/267,280, filed on Dec. 14, 2015.

(51) Int. Cl. G06F 11/14; G06F 9/48

(52) U.S. Cl. CPC G06F 11/1469; G06F 9/485; G06F 11/1464; G06F 2201/84

(57) ABSTRACT

In one example aspect, a method for creating one or more consistent snapshots with a CANDL system is provided. The method is implemented in a database application with a plurality of tiers. The method identifies a set of volumes of tiers that are part of a consistent snapshot group. The method implements a process pause of any processes in the set of volumes of tiers in a specific order. The method obtains a snapshot of the set of volumes of tiers. The method restarts the paused processes in the set of volumes.

### CROSS-REFERENCE TO RELATED APPLICATIONS

This application claims priority to U.S. Provisional Application No. 62/267,280 filed on Dec. 14, 2015 and titled CONTAINER AWARE NETWORKED DATA LAYER. All of these prior applications are incorporated by reference in their entirety. These provisional and utility applications are hereby incorporated by reference in their entirety.

### BACKGROUND

1. Field:

This description relates to the field of container aware networked data layer.

2. Related Art

Application data management is can be difficult when it is sourced from one environment to another in order to provide a seamless experience to the end user. Accordingly, it is important to provide a consistent way of managing application data from one environment to another and also allowing more different copies seeded from the original source for different deployments.

### BRIEF SUMMARY OF THE INVENTION

In one example aspect, a method for creating one or more consistent snapshots with a CANDL system is provided. The method is implemented in a database application with a plurality of tiers. The method identifies a set of volumes of tiers that are part of a consistent snapshot group. The method implements a process pause of any processes in the set of volumes of tiers in a specific order. The method obtains a snapshot of the set of volumes of tiers. The method restarts the paused processes in the set of volumes.

In another aspect, computerized method of container aware-cloud abstracted networked data layer (CANDL) system is disclosed. The method creates a data template from a snapshot with an initial version. The method implements data masking and data shrinking for a new data template version, wherein the new data template is shared to other groups. The method refreshes an original data template from an original data source with a new version of the original data template. The method deletes the original data template.

### BRIEF DESCRIPTION OF THE DRAWINGS

FIG. 1 depicts, in block diagram format, an application lifecycle management system, according to some embodiments.

FIG. 2 illustrates an example host set up, according to some embodiments.

FIG. 3 depicts an exemplary computing system that can be configured to perform any one of the processes provided herein.

FIG. 4 illustrates an example system of an API utilized to implement and manage a CANDL, according to some embodiments.

FIG. 5 depicts an example docker-volume system, according to some embodiments.

FIG. 6 illustrates an example process for creating consistent snapshots with a CANDL system, according to some embodiments.

FIG. 7 illustrates art example process for creating and managing a data catalog with a CANDL system, according to some embodiments.

FIG. 8 illustrates an example process for method for creating one or more consistent snapshots with a CANDL system, according to some embodiments.

FIG. 9 illustrates an example process of a CANDL system, according to some embodiments.

The Figures described above are a representative set, and are not an exhaustive set with respect to embodying the invention.

### DESCRIPTION

Disclosed are a system, method, and article of manufacture for methods and systems of container aware-networked data layer. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’ ‘one example,’ or similar language means that a particular feature, structure, or characteristic described in connection with the embodiment is included in at least one embodiment of the present invention. Thus, appearances of the phrases ‘in one embodiment,’ ‘in an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### DEFINITIONS

Example definitions for some embodiments are now provided.

Application programming interface (API) can be a set of routines, protocols, and tools for building software applications. An API can express a software component in terms of its operations, inputs, outputs, and underlying types. An API can define functionalities that are independent of their respective implementations, which can allow definitions and implementations to vary without compromising the interface.

Application is a collection of software components arranged in a tiered environment.

Asynchronous replication can be implemented between two CVoI on different host (e.g. implemented using ZFS send/receive).

CANDL can be a container aware/cloud abstracted networked data layer.

Clone can be computer hardware and/or software designed to function in the same way as an original.

Data mart can be the access layer of the data warehouse environment that is used to get data out to the users. The data mart can be a subset of the data warehouse that is usually oriented to a specific business line or team.

Docker volumes can be used to create a new volume in a container and to mount it to a folder of a host.

Data Volume is the file system that holds persistent data. The data volume can be implemented on a physical volume (PV) (e.g. any file system) and/or on a CANDL-implemented platform (e.g. using ZFS for initial implementation) called CVoI. The PV can be minimal as they may have a cost associated for P2C.

Physical 2 Container (P2C) or VM to Container (V2C) can be used to move a data from a physical copy to a volume on a CANDL controlled platform.

Snapshot can be the state of a system at a particular point in time.

Virtual machine can be an emulation of a particular computer system. Virtual machine can operate based on the computer architecture and functions of a real or hypothetical computer, and their implementations may involve specialized hardware, software, or a combination of both.

ZFS is a combined file system and logical volume manager designed by Sun Microsystems. The features of ZFS include protection against data corruption, support for high storage capacities, efficient data compression, integration of the concepts of filesystem and volume management, snapshots and copy-on-write clones, continuous integrity checking and automatic repair, RAID-Z and native NFSv4 ACLs.

Zpool can be a collection of one or more vdevs (an underlying device that store the data) into a single storage device accessible to the file system. Each vdev can be viewed as a group of hard disks (or partitions, or files, etc.). Zpool can be a collection of one or more devices that can hold data.

### EXEMPLARY SYSTEMS

The following systems can be used to implement a platform for seamlessly migrating data across divergent cloud platforms while also providing means to manage data in a cloud platform for various applications.

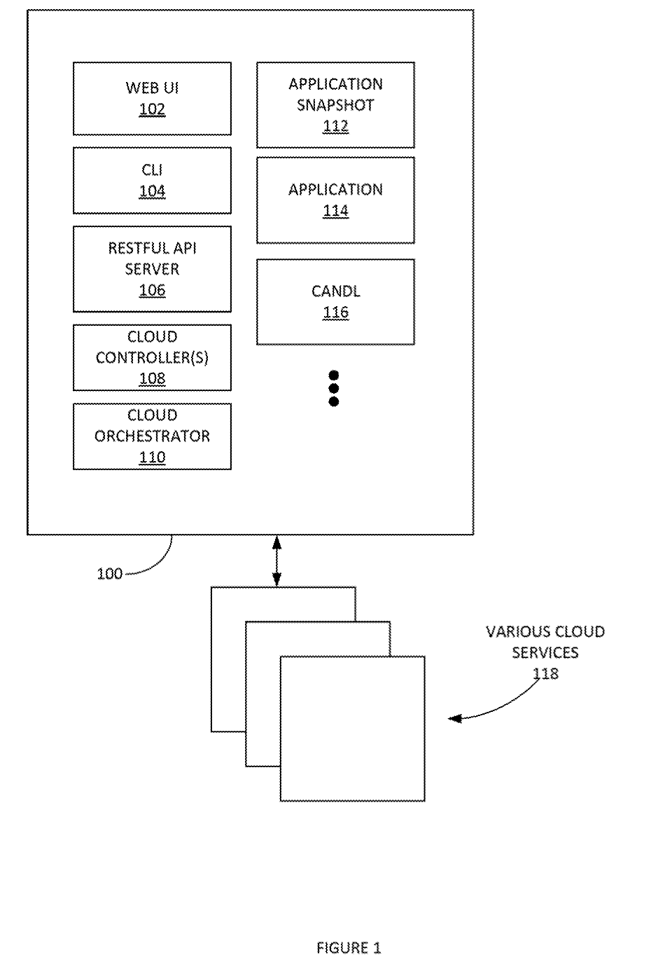

FIG. 1 depicts, in block diagram format, an, application lifecycle management Platform 100, according to some embodiments. Management platform (e.g. management layer) includes various modules like WebUI 102, CLI 104, REST API Server 106, various controllers 108 and/or orchestrators 110 that can be implemented to perform actions such as orchestrating cloud deployments, cluster install and management and also data flow control in order to deploy applications on a given infrastructure setup available or migrate the application to another type of infrastructure (e.g. from a user-side on premise data center to an offsite or public cloud-computing platform). The management platform 100 can control the proper execution of these modules for an effective and seamless management of the application. It is noted that the systems and methods provided herein can also be utilized to migrate applications in any direction between divergent platforms (e.g. back from an offsite cloud-computing platform to a user-side data center. The management platform 100 can include customer-facing aspects and drive the user requests. It can be delivered as a cloud based service (e.g. using a SaaS model). The management platform 100 implements a RESTful API (see infra) and initiate/coordinate with modules provided supra. The management platform 100 can communicate with these modules using a private message-driven API implemented using a ‘message bus’ service. The management platform's user interface (UI) clients can communicate with the management platform using the RESTful API and/or other communication protocol(s). When this application snapshot is captured, the application can be orchestrated through different stages of the application lifecycle, across different cloud hypervisors and storage platforms (e.g. in the transfer, transformation and/or orchestration processes). The management platform 100 can also include application snapshot 112, application 114 and CANDL 116 for implementing the various processes provided infra. The management platform 100 can also include an application catalog, an image catalog and a data catalog. Various cloud services 118 can include a custom or private cloud, a compute and storage pool and/or various third-party cloud-computing services (e.g. Amazon Web Services®, Microsoft Azure®, Openstack®, etc.).

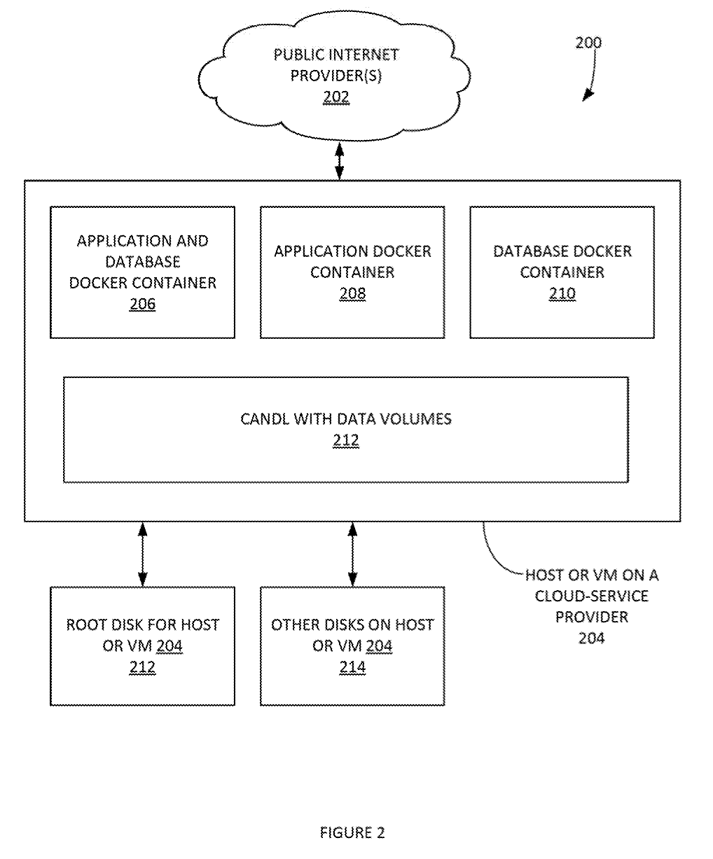

FIG. 2 illustrates an example host set up 200, according to some embodiments. In some embodiments, a zpool (e.g. a Gemini-CANDL, CANDL 212, etc.) can be implemented on each host. host set up 200 can include a host or virtual machine (VM) on a cloud-computing platoform 204. Host or virtual machine (VM) 204 can be coupled with one or more Internet provider(s) 202. Host or virtual machine (VM) 204 can include application and database docker container 206, application docker container 208, and database docker container 210. CANDL with data volumes 212 can be utilized. For example in some embodiments, when a volume is created, an option to set a second hostname can be provided. This can setup a continuous asynchronous replication to the second host. A data user can be set between the two hosts to send and receive snapshot data (e.g. zpool create Gemini-CANDL SCD). SCD can the name of the vdev or disk on how it shows up on a Linux disk.

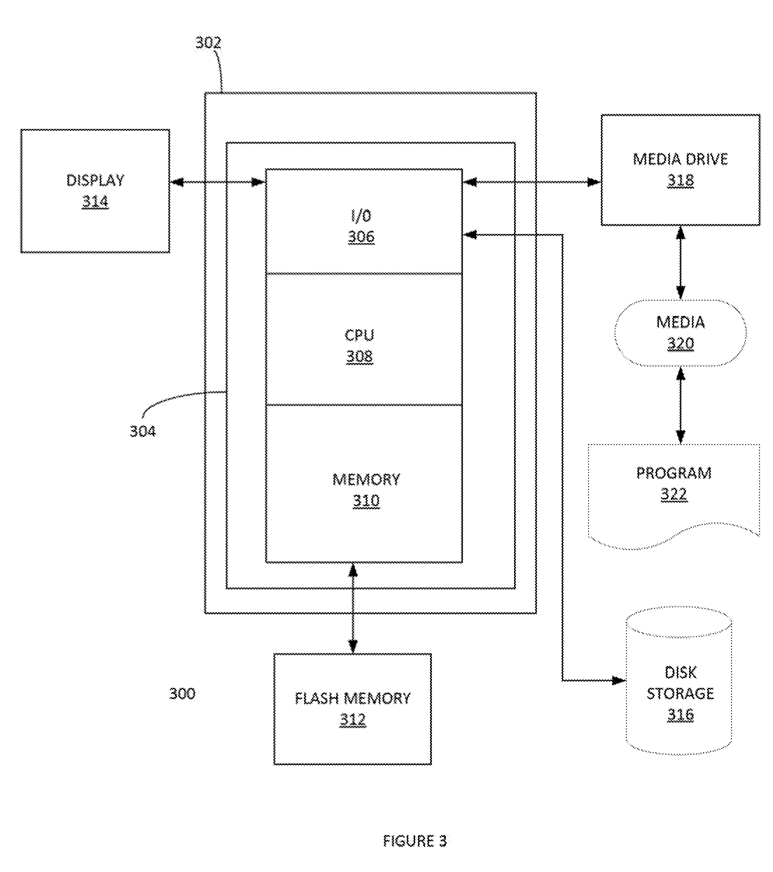

FIG. 3 depicts an exemplary computing system 300 that can be configured to perform any one of the processes provided herein. In this context, computing system 300 may include, for example, a processor, memory, storage, and I/O devices (e.g., monitor, keyboard, disk drive, Internet connection, etc.). However, computing system 300 may include circuitry or other specialized hardware for carrying out some or all aspects of the processes. In some operational settings, computing system 300 may be configured as a system that includes one or more units, each of which is configured to carry out some aspects of the processes either in software, hardware, or some combination thereof.

FIG. 3 depicts computing system 300 with a number of components that may be used to perform any of the processes described herein. The main system 302 includes a motherboard 304 having an I/O section 306, one or more central processing units (CPU) 308, and a memory section 310, which may have a flash memory card 312 related to it. The I/O section 306 can be connected to a display 314, a keyboard and/or other user input (not shown), a disk storage unit 316, and a media drive unit 318. The media drive unit 318 can read/write a computer-readable medium 320, which can contain programs 322 and/or data. Computing system 300 can include a web browser. Moreover, it is noted that computing system 300 can be configured to include additional systems in order to fulfill various functionalities. Computing system 300 can communicate with other computing devices based on various computer communication protocols such a Wi-Fi, Bluetooth®(and/or other standards for exchanging data over short distances includes those using short-wavelength radio transmissions), USB, Ethernet, cellular, an ultrasonic local area communication protocol, etc.

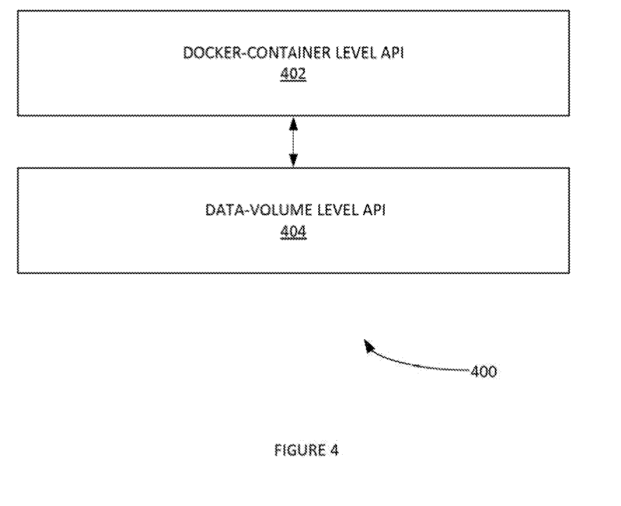

FIG. 4 illustrates an example system 400 of an API utilized to implement and manage a CANDL, according to some embodiments. It is noted that U.S. Provisional Application No. 62/267,280 filed on Dec. 14, 2015, which is hereby incorporated by reference includes a table of API signatures can be used to implement process 400.

API system 400 can be a two-layer API system. API layer 402 can works on a docker-container level. API layer 402 can apply to data volumes for a container. API layer 404 can works on each data-volume level. API layer 404 manage a single volume at a time. Container level API system 400 need not mention each data volume as they can be persisted in a configuration file. Additionally, an initial setup and administration related API can be used to setup and manage zpools.

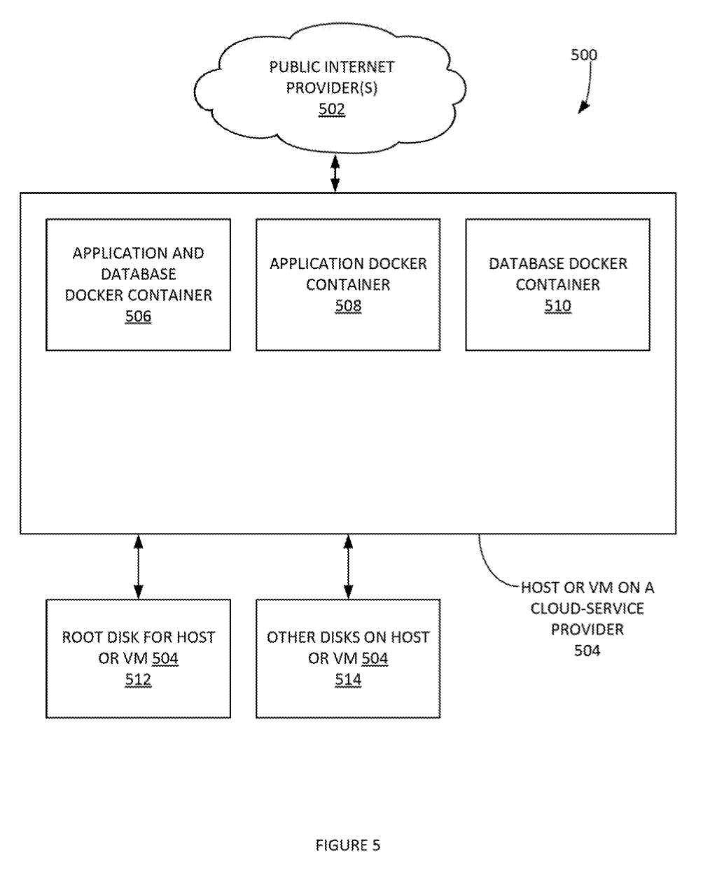

FIG. 5 depicts an example docker-volume system 500, according to some embodiments. Docker-volume system 500 can use the same host requirements. Host or virtual machine (VM) 504 can be coupled with one or more Internet provider(s) 502. Host or virtual machine (VM) 504 can include application and database docker container 506, application docker container 508, and database docker container 510. Docker-volume system 500 can be shared and reused between containers. Docker-volume system 500 can directly implement changes to a data volume. Changes to a data volume may not be included with the update image. Volumes can persist until no containers use them. For example, a first mount of any volume to be used as data volume can be implemented (e.g. docker run -d -P --name web -v/src/webapp:/opt/webapp training/webapp python app.py). It is noted that containers can have one or more data volumes.

### EXAMPLE METHODS

The methods and systems provided supra can be used to implement, inter alia, the following use cases: easy Initial Installation/setup; create from scratch one or more data volumes for a docker container; import one or more native data volume of a docker container into pool; snapshot running data volumes for a docker container; restore from a previous snapshot of data volumes for a docker container; restore from a previous snapshot on different host (DR); clone from snapshot to same host (e.g. read/write access, etc.); clone from snapshot to different host (e.g. scaling beyond host, etc.); DB specific clustering using clones (e.g. Mongo clustering, etc.); create QA clones with data masking from production snapshot (e.g. role-based access control (RBAC), etc.); basic management of various data templates (e.g. a repository, etc.); etc. An example usage scenario can be the following sequence: Dev Development Functional QA Test->Staging Load testing->Production.

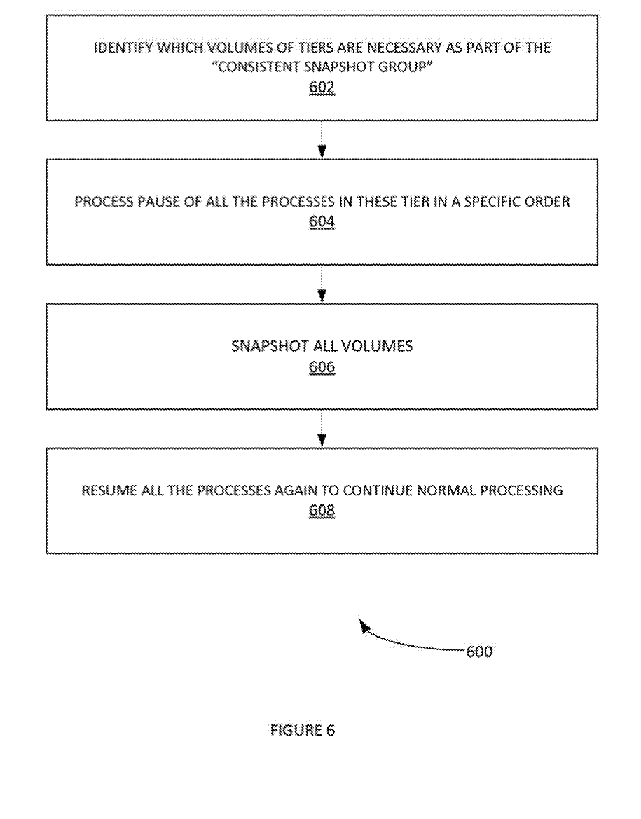

FIG. 6 illustrates an example process 600 for creating consistent snapshots with a CANDL system, according to some embodiments. Process 600 can identify which volumes of tiers are necessary as part of the “consistent snapshot group” in step 602. Process 600 can implement a process pause of the processes in these tier in a specific order in step 604. Process 600 can implement a snapshot the volumes in step 606 (e.g. all the volumes). Process 600 can resume all the processes again to continue normal processing in step 608.

It is noted that process 600 can leverage snapshots provided by underlying storage implementation. Process 600 can achieve a snapshot that is always restorable to the time a snapshot as taken. Process 600 can implement a database application with multiple tiers including clients operating on the database tier which is a multi-node tier. In order to restore it, process 600 can first figure out the volumes of the tiers (e.g. all the tiers) are necessary as part of the “consistent snapshot group”. Next process 600 can process pause of the processes in these tier in a specific order in order to make sure that no writes are pending on the underlying storage of the tiers. Process 600 can implement a snapshot on the volumes. Next process 600 can resume the processes again to continue normal processing. When such a snapshot is restored, the databases use the database recovery to restore the database tier to the status.

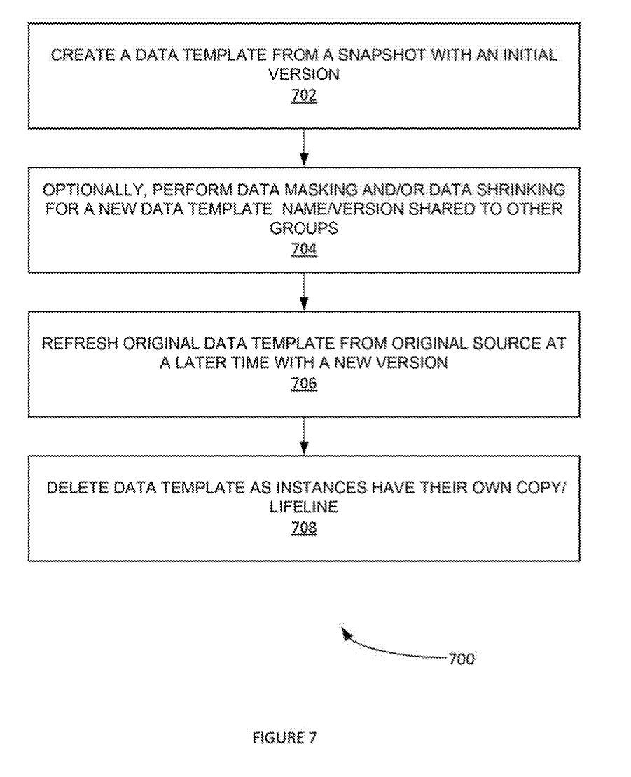

FIG. 7 illustrates an example process 700 for creating and managing a data catalog with a CANDL system, according to some embodiments. Process 700 can create a data template from a snapshot with an initial version in step 702. Optionally, process 700 can perform data a masking and/or data shrinking for a new data template name/version shared to other groups in step 704. Process 700 can refresh original data template from original source at a later time with a new version in step 706. Process 700 can delete data template as instances have their own copy/lifeline in step 708. For example, using CANDL as the data platform, now various data marts can be made available to be shared for different instances (e.g. beyond a normal snap, clone use cases, etc.).

A use case is now provided by way of example. A production database can be shared to a developer environment for testing. In some cases, process 700 can remove sensitive information before it is made available for developer environment. This can be run outside of the cluster of production environment and the access of the user accessing it can also be different from typical production administrators. This type of use case can be supported by Data Catalog where the original persistent data of an application is made available to developers as a template.

One example implementation of using CANDL for process 700 can be as follows. A special pool can be created using a CANDL workflow which is used for Data Catalog process 700. This pool can be used for storing a Data Template. The Data Template can be a collection of various “Snapshotted” volumes from various tiers of an application. When a fresh snapshot is taken (or from an existing snapshot), then that version of the volume can be copied over to the Data Catalog pool in a different node. This Data Template can be used for new instances of the application that are spun up. Also this Data Template can be refined by using, inter alia: Data Masking, Data Shrinking, etc. capabilities to remove sensitive data. It can then be made available using Role-Based Access Control to different groups for development/testing of new versions of applications. The new version of applications may not be in the same compute/data pool as the production instances.

Example use cases of Data Catalog can be as follows: simple DR Option of Data; seed data for new instances of an application; golden data copy for brown field import of data from a live application outside a specified platform; post processed data which can be used for development/testing; etc.

An example, Greenfield docker container is now discussed. In one example, a docker container “mongodb1” is created on Host1 with a data volume “mongodb1”. A data volume called “mongodb” on Host1 can be created. For example, a ZFS can create gemini-candl/mongodb1. If a user also wants a high availability mode for the data then, in the background, it can also start a background task to send the ZFS volume from Host1 to Host2 using either ZFS send/receive. Whenever named snapshots are created on a local ZFS, a snapshot with the same name on both local ZFS and second host with that reference can also be created (e.g. ZFS snapshot gemini-candl/mongodb@nov2014, etc.). A rollback, if needed, can be done as follows. The ZFS can rollback gemini-candl/mongodb@nov2014.

A clone can be created using a snapshot (e.g. either named and/or an automatically created snapshot). Automatic snapshots can be once every hour (e.g. for 6 hours), once every day (for a week), once every week for 4 weeks, once every month, and so on. (We can have a default policy which the customers can modify if needed.). Once a clone is created it can be renamed to a new CVoI name and for various purposes can be considered as a separate CVoI (e.g. even though internally ZFS may be sharing pages till a Copy-On-Write happens). For example, a ZFS clone can be implemented as follows: gemini-candl/mongodb@nov2014 gemini-candl/mongodb2.

An example of removing a volume is now provided. In some examples, a snapshot cannot be deleted if a clone exists (e.g. in ZFS since a clone is light weight it uses the snapshot as base layer for the clone). When the original volume is to be deleted, the rename command can be used so that the name can be reused. For example, a ZFS can rename gemini-candl/mongodb to gemini-candl/mongodb_old). Otherwise if there are no clones we can just delete the volume or cloned volume as follows: ZFS can destroy gemini-candl/mongodb. It is noted that snapshots can be destroyed before a volume can be destroyed (or use -r to delete snapshots also). Snapshots with clones may not be destroyed.

An example of Brownfield migration of an existing docker container is now provided. For physical volumes there may be a way to create a P2C CloudVolume on a second host. In this example, the API goes through the data management layer or in the cloud (e.g. which keeps track of the snapshots and the pools they are created). From user point of view, the volume names are unique. However, in the case of a multiple zpool, enforcement can be performed via a layer that validated the API values. The implementation can be performed ‘behind the scene’. The metadata can be stored in some persistent layer in the data management layer and/or in some database that is used by the rest of the management server.

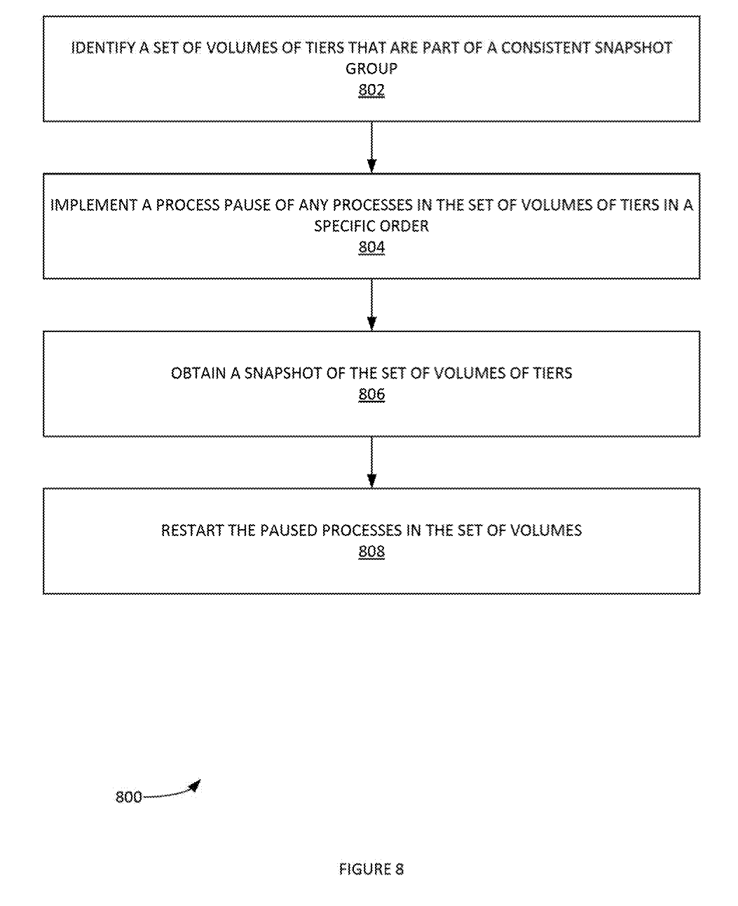

FIG. 8 illustrates an example process 800 for method for creating one or more consistent snapshots with a CANDL system, according to some embodiments. Process 800 can be implemented in a database application with a plurality of tiers. In step 802, process 800 can identify a set of volumes of tiers that are part of a consistent snapshot group. In step 804, process 800 can implement a process pause of any processes in the set of volumes of tiers in a specific order. In step 806, process 800 can obtain a snapshot of the set of volumes of tiers. In step 808, process 800 can restart the paused processes in the set of volumes.

A tier is a logical classification of an application layer that does a specific function. For example, it could be a web server tier, application server tier, database tier or file server tier. It can be an equivalent of a microservice layer in some embodiments. The underlying storage process can be either a storage layer (e.g. starling or another project such as ZFS (e.g. a combined file system and logical volume manager designed by Sun Microsystems), cloud tiers such as AWS EBS (Amazon Elastic Block Store®—an Amazon web service providing persistent high volume storage for cloud based EC2 (Amazon Elastic Compute Cloud) servers) and/or storage array functions such as hardware snapshots).

A consistent snapshot group is a set of volumes which can help recover/restart an application on a different set of resources in a way where the perceived consistency of application data preserved. It is noted that a stateless tier's data may not be material to be backed up as it is discarded during shutdown anyway. Accordingly, its data need not be part of the consistency snapshot group.

A multi-node tier is described as the same logical tier which is deployed on multiple servers or VMs with a common front end. A common example can be a multi-node database such as, for example, Cassandra® or MongoDB®, that are deployed on multiple servers yet many times behave like one irrespective of where the clients connect. A transaction system can be a system where various (e.g. all) operations can be carried out as a single unit of work which is either committed or rolled back without leading to partial completion.

A Data template can be created from a running application where we can take the snapshot of the running application data and then make the data as a cleaned-up copy to be used as a template for multiple new copies of the same application. This can assist in reproduction of the data in a test environment rapidly.

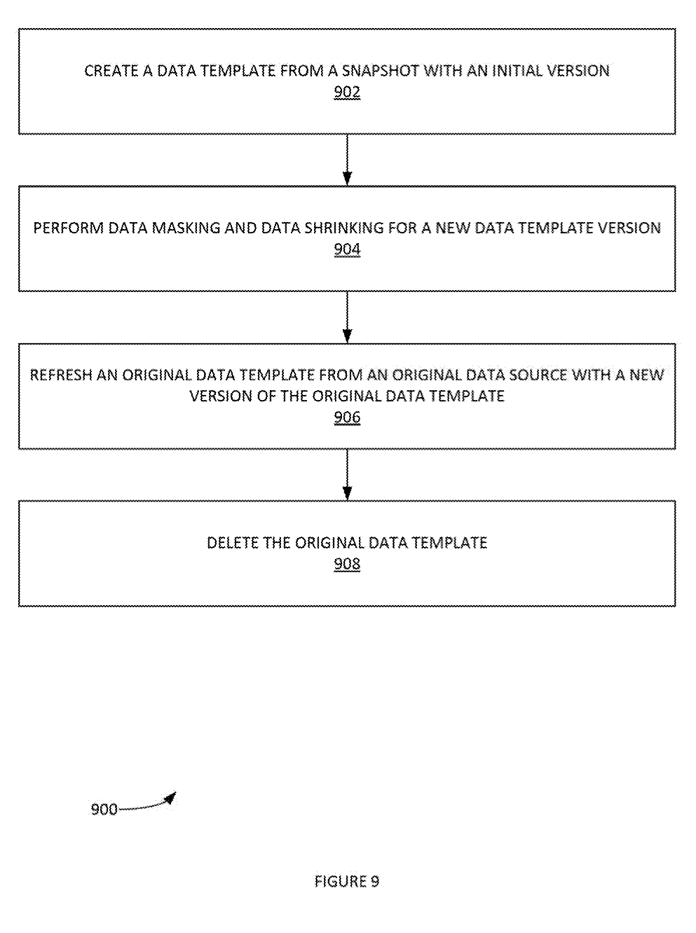

FIG. 9 illustrates an example process 900 of a CANDL system, according to some embodiments. In step 902, process 900 can create a data template from a snapshot with an initial version. In step 904, process 900 can perform data masking and data shrinking for a new data template version, wherein the new data template is shared to other groups. In step 9-6, process 900 can refresh an original data template from an original data source with a new version of the original data template. In step 908, process 900 can delete the original data template. It is noted that ‘other groups’ can include user teams. For example, a production group can obtain the data from production database and then anonymize it and share it with a development team and/or testing team. Example instances can be instances of such data , inter alia: a pre-production deployment instance; an upgrade testing instance; a technical support deployment instance; a stress testing instance; a functional testing instance; a development instance; etc.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. A computerized method for creating one or more consistent snapshots with a container aware-cloud abstracted networked data layer (CANDL) system comprising:
in a database application with a plurality of tiers;
identifying a set of volumes of tiers that are part of a consistent snapshot group;
implementing a process pause of any processes in the set of volumes of tiers in a specific order;
obtaining a snapshot of the set of volumes of tiers; and
restarting paused processes in the set of volumes.

2. The computerized method of claim 1, wherein the snapshot comprises a snapshot provided by an underlying storage processes.

3. The computerized method of claim 1 wherein the database application includes a set of clients operating on a database tier.

4. The computerized method of claim 3, wherein the database tier comprises a multi-node tier.

5. The computerized method of claim 4, wherein when the snapshot is restored, the database application uses a database recovery process to restore at least one database tier in the snapshot.

6. A transaction server system comprising:
a processor that implements a container aware-cloud abstracted networked data layer (CANDL) system, wherein the processor configured to execute instructions;
a memory containing instructions when executed on the processor, causes the processor to perform operations that:
in a database application with a plurality of tiers;
identify a set of volumes of tiers that are part of a consistent snapshot group;
implement a process pause of any processes in the set of volumes of tiers in a specific order;
obtain a snapshot of the set of volumes, of tiers; and
restart paused processes in the set of volumes.

7. The server system of claim 6, wherein the snapshot comprises a snapshot provided by an underlying storage processes.

8. The server system of claim 6, wherein the database application includes a set of clients operating on a database tier.

9. The server system of claim 8, wherein the database tier comprises a multi-node tier.

10. The server system of claim 9, wherein when the snapshot is restored, the database application uses a database recovery process to restore at least one database tier in the snapshot.

11. A computerized method of container aware-cloud abstracted networked data layer (CANDL) system comprising:
creating a data template from a snapshot with an initial version;
implementing data masking and data shrinking for a new data template version, wherein the new data template is shared to other groups;
refreshing an original data template from an original data source with a new version of the original data template; and
deleting the original data template.

12. The computerized method of claim 11, wherein using the CANDL system as a data platform.

13. The computerized method of claim 12, wherein a set of data marts are made available to be shared for different instances.
